(19) United States
(12) Patent Application Publication
(10) Pub. No.: US 2023/0280018 A1
(43) Pub. Date: Sep. 7, 2023

(54) LED LIGHT MODULE WITH MOLDED SILICONE OPTICS

(71) Applicant: ABL IP Holding LLC, Atlanta, GA (US)

(72) Inventors: Jie Chen, Snellville, GA (US); Qi Ai, Peachtree City, GA (US); Craig Eugene Marquardt, Covington, GA (US)

(21) Appl. No.: 18/115,952

(22) Filed: Mar. 1, 2023

Related U.S. Application Data
(60) Provisional application No. 63/316,645, filed on Mar. 4, 2022.

(51) Int. Cl. F21V 17/10; F21V 31/03; F21V 7/00

(52) U.S. Cl. CPC F21V 17/101; F21V 31/03; F21V 7/0091

(57) ABSTRACT

Light modules with lens assemblies having one or more silicone components such as silicone optics and/or a silicone lens substrate. Embodiments also include attachment features and/or thermal control features that may be used to improve performance of the light modules with lens assemblies having the silicone components. Adhering features and/or thermal control features may be included with the light module having the lens assemblies with one or more silicone components.

### REFERENCE TO RELATED APPLICATION

This application claims the benefit of U.S. Provisional Patent Application No. 63/316,645, filed on Mar. 4, 2022, and entitled LED LIGHT MODULE WITH MOLDED SILICONE OPTICS, the content of which is hereby incorporated by reference in its entirety.

### FIELD OF INVENTION

The present technology relates to light modules, and more particularly to light modules with molded silicone optics.

### DESCRIPTION OF THE RELATED ART

Light modules with arrayed optics are used in a various indoor and outdoor settings, such as but not limited to roadway lights or area lights. Typical light modules have a multi-part and complex construction. For example, they typically include (i) a printed circuit board (PCB) with light emitting diodes (LED) provided on the PCB in the desired number and array configuration, (ii) a lens that is positioned and attached over the PCB, (iii) one or more gaskets to seal the module against ingress of moisture and particulates that can damage the PCB and detrimentally impact operation of the LEDs, and (iv) a frame to hold all of these parts together. Optics are formed in the lens such that each optic will align with an LED when the light module is assembled. The lens (and associated optics) is typically molded from an optical grade plastic material, such as polymethylmethacrylate (PMMA) or polycarbonate (PC). While such light modules are relatively easy to add like building blocks into a light fixture if additional lumens are needed, their multi-part, complex construction increases material costs, assembly time/costs, and the risk of product failure.

### BRIEF SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the present disclosure are directed towards light modules with lens assemblies having one or more silicone components such as silicone optics and/or a silicone lens substrate. Embodiments also include attachment features and/or thermal control features that may be used to improve performance of the light modules with lens assemblies having the silicone components. Adhering features and/or thermal control features may be included with the light module having the lens assemblies with one or more silicone components.

### BRIEF DESCRIPTION OF THE FIGURES

FIG. 1 is a bottom perspective view of a light module according to embodiments.

FIG. 2 is a top perspective view of the light module of FIG. 1.

FIG. 3 is an exploded view of the light module of FIG. 1.

FIG. 4 is a bottom perspective view of the light module of FIG. 1 with a lens assembly removed.

FIG. 5 is a top perspective view of the light module of FIG. 1 with a printed circuit board removed.

FIG. 6 is a sectional view of the light module of FIG. 1.

FIG. 7 is a sectional view of FIG. 1 taken from the dashed box in FIG. 6.

FIG. 8 is a top perspective view of a lens assembly of the light module of FIG. 1.

FIG. 9 is an exploded view of the lens assembly of FIG. 8.

FIG. 10 is a bottom perspective view of the lens assembly of FIG. 8.

FIG. 11 is a sectional view of an optic of the lens assembly of FIG. 8.

FIG. 12 illustrates an example of a prior art optic.

FIG. 13 is a bottom perspective view of another light module according to embodiments.

FIG. 14 is a perspective view of another light module according to embodiments.

FIG. 15 is a top perspective view of a lens assembly of the light module of FIG. 14.

FIG. 16 is a bottom perspective view of another light module according to embodiments.

FIG. 17 is a bottom view of the light module of FIG. 16.

### DETAILED DESCRIPTION

Described herein are light modules with improved constructions allowing for simplified assembly, which in turn may reduce assembly time, assembly costs, and material costs. The components and features of the light modules described herein may also improve the optical performance of the light module compared to traditional light modules, including but not limited to providing wider light distributions, improved uniformity, and improved backlight control. The light modules provided herein may also minimize and/or eliminate potential performance issues caused by heat generated by light sources of the light modules. Advantageously, optics of the light modules provided herein may be constructed from silicone, which may improve manufacturing of such optics as well as performance of the light module; however, the optics provided herein are not limited to silicone optics. Various other benefits and advantages may be realized with the systems and methods provided herein, and the aforementioned advantages should not be considered limiting.

### Light Module

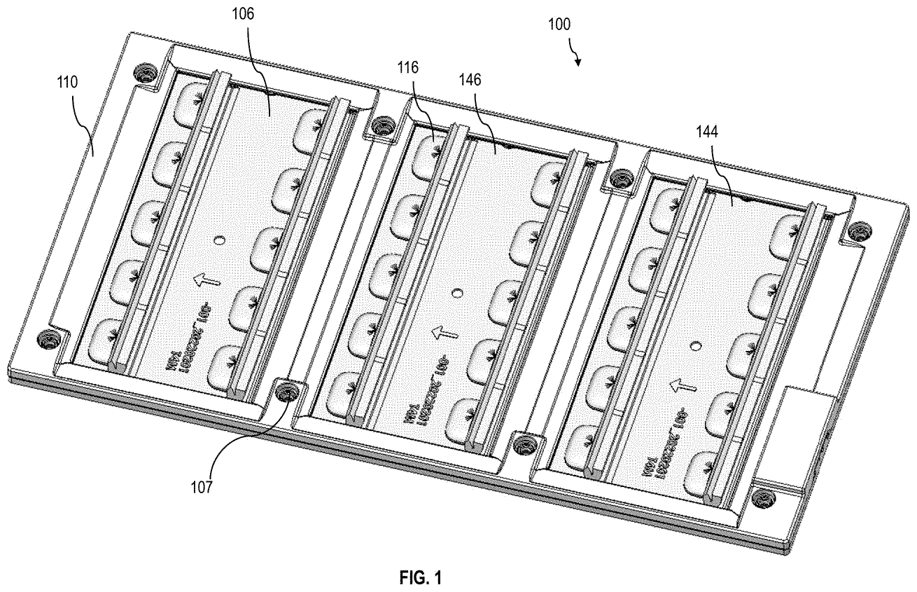

FIGS. 1-11 illustrate a light module 100 according to various embodiments. The light module 100 may be a component of various types of light fixtures as desired. In some embodiments, the light fixture with the light module 100 may be or be used within an outdoor fixture, such as, but not limited to, a streetlight, a floodlight, etc. The light module 100 includes a PCB 102 with one or more light sources 104, one or more lens assemblies 106, and one or more attachment mechanisms 108. Optionally, the light module 100 includes a frame 110, although in other embodiments the light module 100 need not include the frame 110.

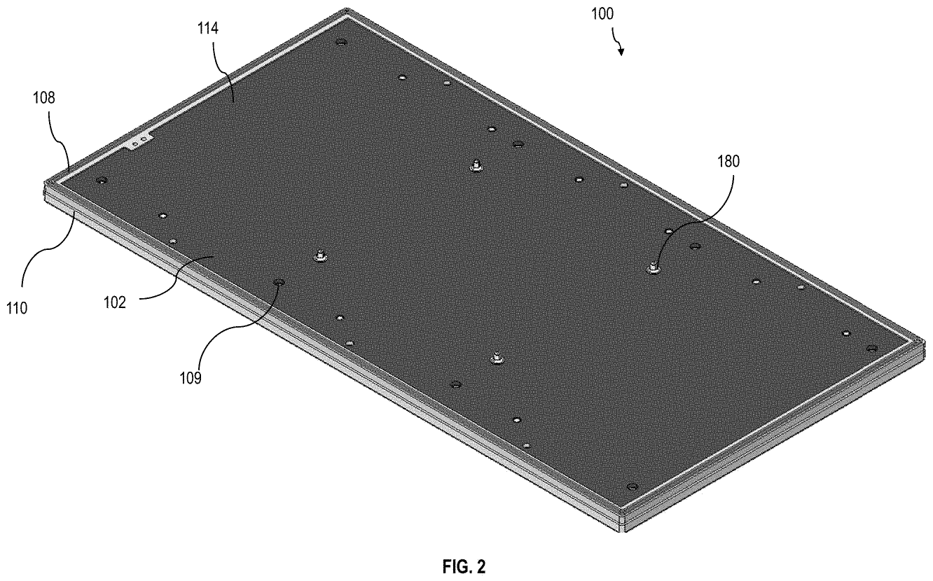

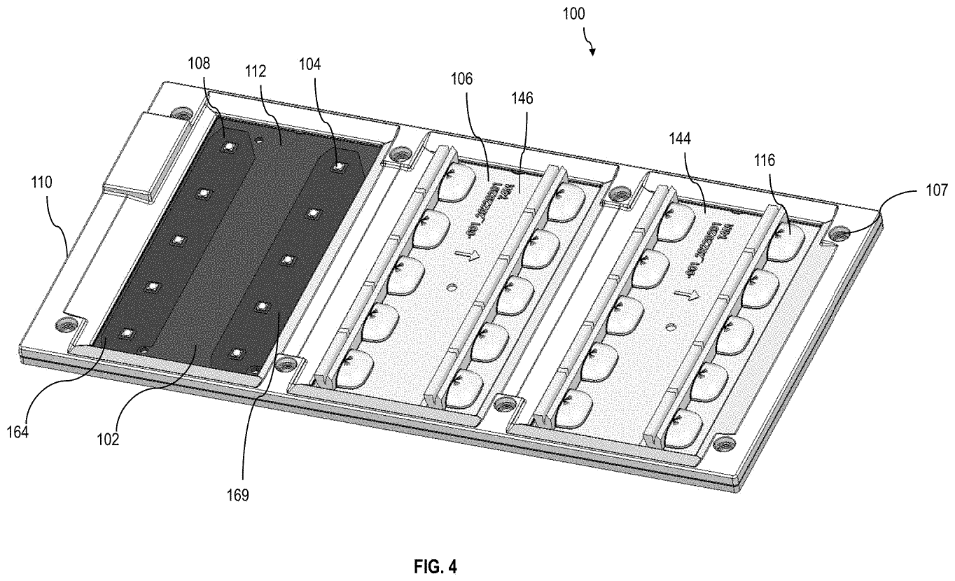

The PCB 102 generally includes a first surface 112 (see FIG. 4) and an opposing second surface 114 (see FIG. 2). The one or more light sources 104 may be provided on the first surface 112. The one or more light sources 104 may include any suitable source of light, including but not limited to a LED, an OLED, an incandescent bulb, combinations thereof, or other sources as desired. Moreover, any number of light sources 104 may be provided on the PCB 102, and when a plurality of light sources 104 are included, the light sources 104 may be provided in various numbers, patterns, and/or arrangements on the PCB 102 as desired. In the embodiment of FIGS. 1-11, the light module includes a plurality of LEDs as the light sources 104 that are arranged in rows of five across on the PCB 102.

The one or more lens assemblies 106 may be attached to the first surface 112 of the PCB 102 for controlling light distribution from the one or more light sources 104. Any number of lens assemblies 106 may be used as desired. In the embodiment illustrated, the light module 100 includes three lens assemblies 106.

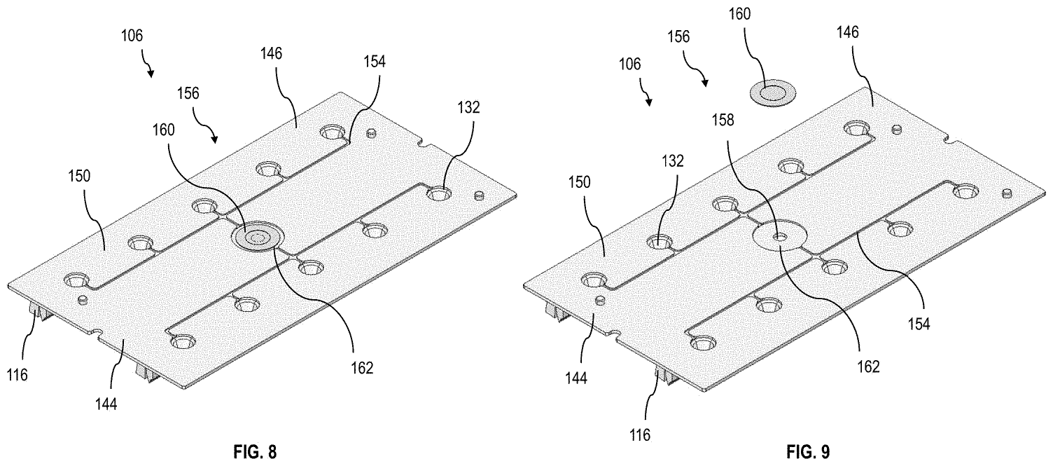

Each lens assembly 106 includes at least one optic 116 that is positioned over a corresponding light source 104, and in certain embodiments, a lens assembly 106 may include a plurality of optics 116. When a plurality of optics 116 are included, the optics 116 may be molded or otherwise formed together as illustrated in FIGS. 8-11, for example, or the optics 116 may be independent (discrete) from each other. The optics 116 may be formed of any suitable material, including, but not limited to, silicone, glass, and optical grade plastic materials such as optical grade acrylics (e.g., optical grade PMMA) and optical grade polycarbonate.

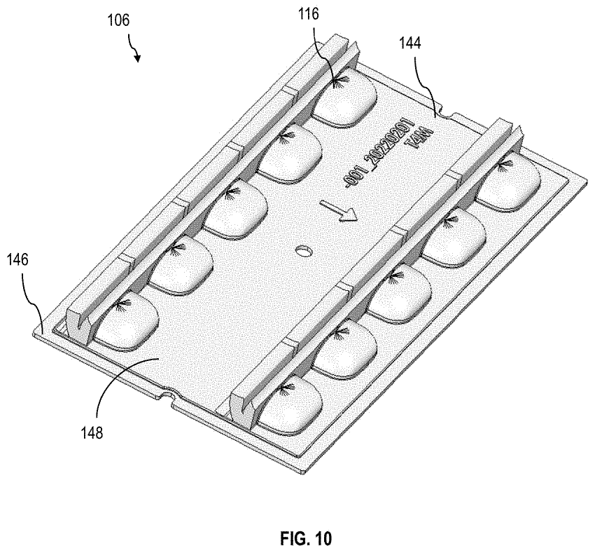

In addition to the one or more optics 116, a lens assembly 106 may include lens 144. The lens 144 includes a lens substrate 146 having a first side 148 (FIG. 10) and an opposing second side 150 (FIGS. 8 and 9). One or more optics 116 are provided on the lens substrate 146 and extend from a first side 148 of the lens substrate 146. Each optic 116 includes an optical cavity 132 (FIGS. 8 and 9) with an opening exposed on the second side 150 of the lens substrate 146. When the optics 116 are positioned over the light sources 104, the light sources 104 are received within optical cavities 132. Any number of optics 116 may be provided on the lens 144 in any arrangement and orientation. In some embodiments, each optic 116 may be formed separately and secured to the lens substrate 146. In other embodiments, a row of optics 116 is integrally formed and subsequently secured to the lens substrate 146. In still other embodiments, the optics 116 and lens substrate 146 are formed integrally with each other to form a monolithic lens assembly 106. In some embodiments, the lens 144 may be constructed from the same material as the optics 116. As a non-limiting example, the lens 144 may be constructed from the same optical grade silicone as the optics 116. In such embodiments, the lens 144 and the optics 116 may be integrally formed or separately formed. In other embodiments, the lens 144 may be constructed from a material that is different from the optics 116. As an example, the lens 144 may be constructed from a first type of optical grade silicone or acrylic, and the optics 116 may be constructed from a second type of optical grade silicone.

Optionally, the lens 144 may include one or more light extraction features for extracting light from the lens 144. Such light extraction features may be provided on either side 148, 150 of the lens substrate 146 and/or within the lens substrate 146 to disrupt any internal reflection condition so that light can be redirected downwards and out of the lens substrate 146. In some embodiments, the light extraction features include a texturized surface provided on at least one side 148, 150 of the lens substrate 146. Such a texturized surface may be formed via embossing, sandblasting, combinations thereof, and/or other suitable techniques as desired. In some embodiments, light extraction features may comprise particulates provided with in the lens substrate 146, optical prisms, bubbles, combinations thereof, and/or other types of light extraction features as desired. Such light extraction features may improve the optical performance of the light module 100 by minimizing light that would otherwise be lost due to internal reflection, which may improve the lumens per watt, reduce pixilation, and/or minimize contrast between optics 116. The type, orientation, and density of extraction features may be varied to control the output light distribution.

Various attachment features may be used to assemble the light module 100, including but not limited to mechanical fasteners and/or chemical fasteners as desired. In the embodiment illustrated in FIG. 1, the attachment features include apertures 107 that are defined in the frame 110 (and optionally in a plate 168) for receiving mechanical fasteners (e.g., bolts, screws) that in turn engage corresponding apertures 109 in the PCB 102. However as mentioned, in other embodiments, other attachment features may be used, including but not limited to clips, clasps, hooks, snap-fit connectors, combinations thereof, and/or other suitable mechanisms or features as desired.

### Attachment Mechanisms

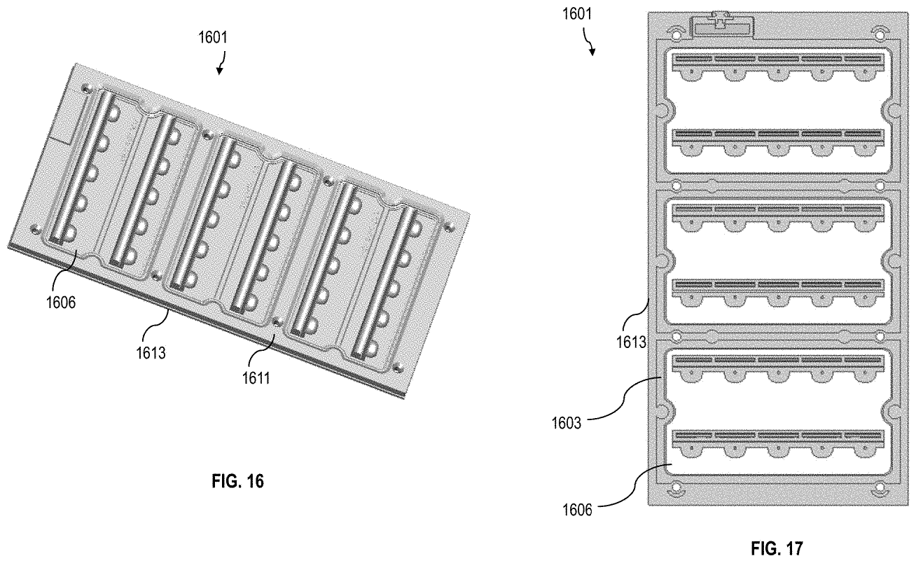

The one or more attachment mechanisms 108 may be used to attach the lens assemblies 106 with the PCB 102. Various types of attachment mechanisms 108 may be utilized, and in some embodiments, a plurality of types of attachment mechanisms 108 may be utilized. The attachment mechanisms 108 may secure the lens assemblies 106 to the PCB 102 and prevent or minimize movement of the lens assemblies 106 relative to the PCB 102. Such attachment mechanisms 108 may be particularly suitable for (but are not limited to) light modules 100 with silicone lens assemblies 106 and may bond the lens assemblies 106 to the PCB 102 to maintain proper position, physically press the lens assemblies 106 toward the PCB 102, and/or otherwise hold the lens assemblies 106 in place on the PCB 102. The attachment mechanisms 108 may also allow for a simplified construction of the light module 100 that may omit gaskets, frames, and other components that have traditionally been required. FIGS. 16 and 17, by comparison, illustrate a prior art light module 1601 with lens assemblies 1606 supported between an upper frame 1611 and a lower frame 1613. As illustrated in FIG. 17, gaskets 1603 are required around each lens assembly 1606 to seal the light module 1601. However, as illustrated, these additional components require additional assembly compared to the light modules of the disclosure.

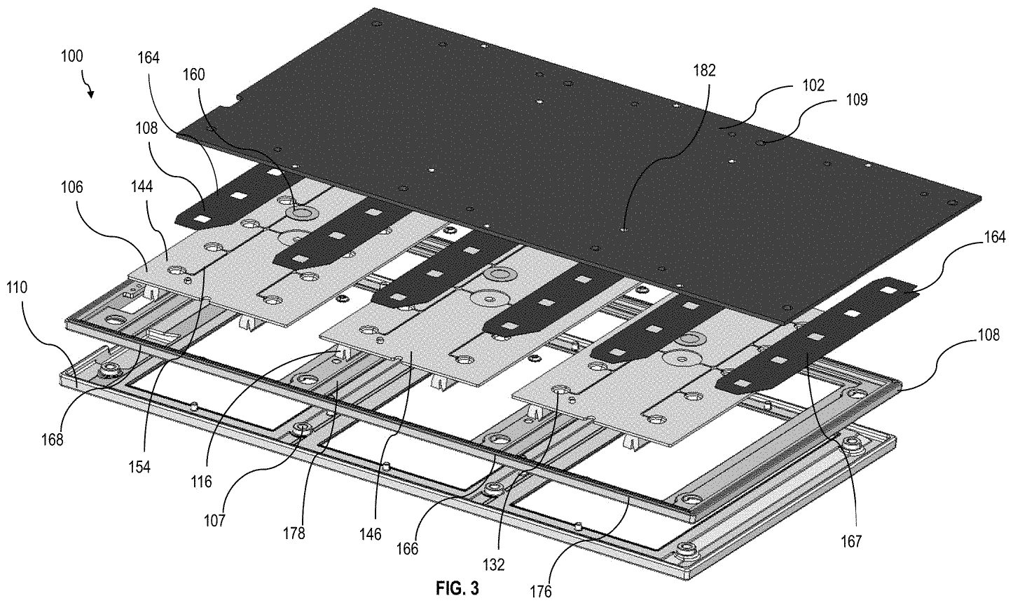

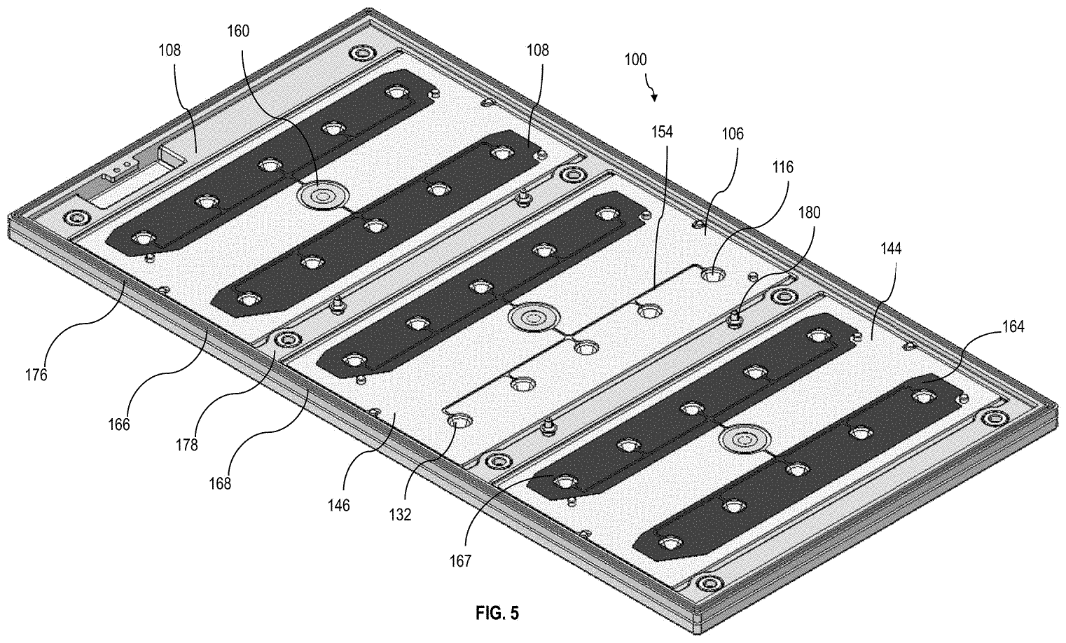

Referring to FIGS. 3-5, in some embodiments, the attachment mechanisms 108 may include one or more adhesives. While adhesive may be applied directly to the PCB 102, in the illustrated embodiments adhesive tape 164 is used to secure the lens assemblies 106 to the PCB 102. The adhesive tape 164 includes a first side 167 (FIGS. 3 and 5) that is adhered to the PCB 102 and a second side 169 (FIG. 4) that is adhered to the lens assemblies 106. In certain embodiments, the adhesive tape 164 may be a double-sided tape and/or a double-coated tape, including but not limited to a silicone/acrylic double-coated tape. Non-limiting examples of suitable adhesive tapes 164 include, but are not limited to, those sold under the trade name 3M™ Silicone/Acrylic Double Coated Tapes 9731-050, 9731-085, and 9731-100 by 3M Company and/or those sold under the trade name FS-2256h Silicone/Acrylic Double Sided Tape by DST Tapes, Inc.

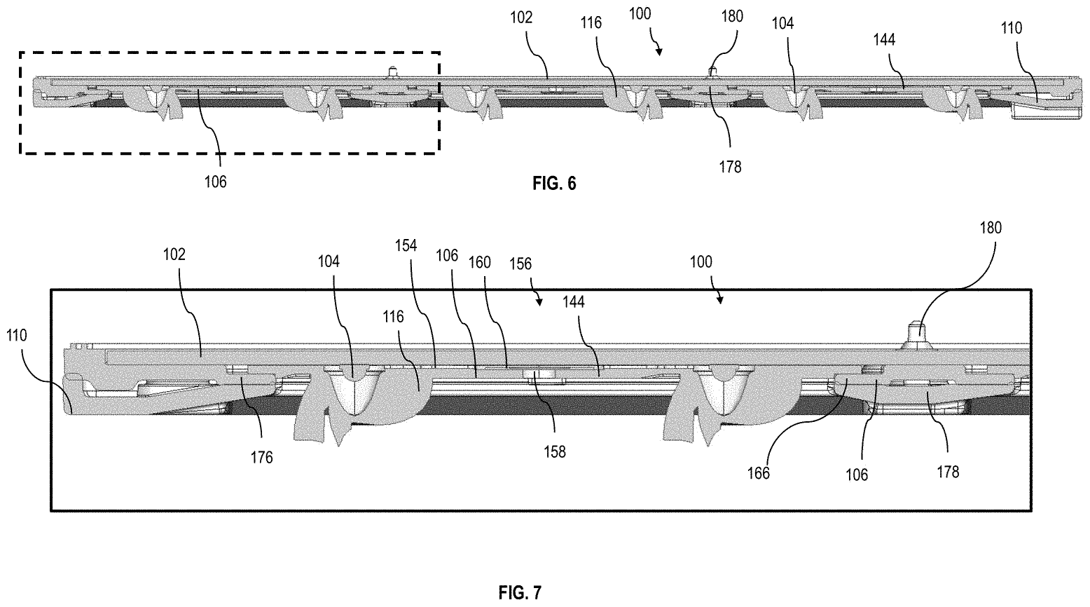

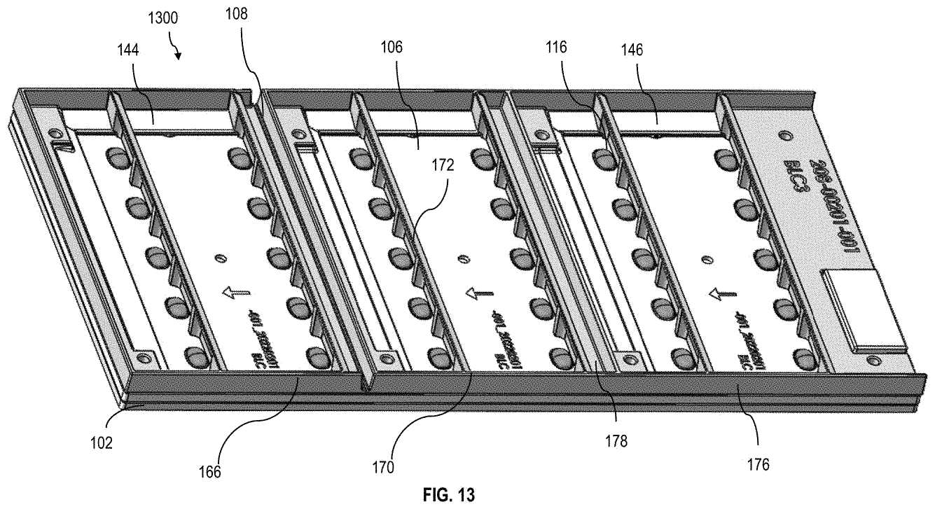

Referring to FIGS. 1-7 and as best illustrated in FIGS. 6 and 7, in various embodiment the attachment mechanisms 108 may include a compression component 166 designed to physically press the lens assemblies 106 toward the PCB 102. In the embodiment illustrated in FIGS. 1-7, the compression component 166 is a plate 168 having an outer frame 176 and crossbars 178 that extend across the outer frame 178 to define apertures through which light may pass. Attachment features 180 on the crossbars 178 (or at other locations) may engage apertures 182 of the PCB 102 such that the plate 168 applies pressure on the lens assemblies 106; however, other techniques may be used to attach the plate 168 such that the plate 168 applies pressure on the lens assemblies 106. In some embodiments (see FIG. 13), the crossbars 178 are located proximate the optics 116 (and associated light sources 104) such that the crossbars 178 may serve to influence the directionality of light exiting an optic 116. The crossbars 178 may be designed to have any shape and surface enhancements to direct emitted light as desired.

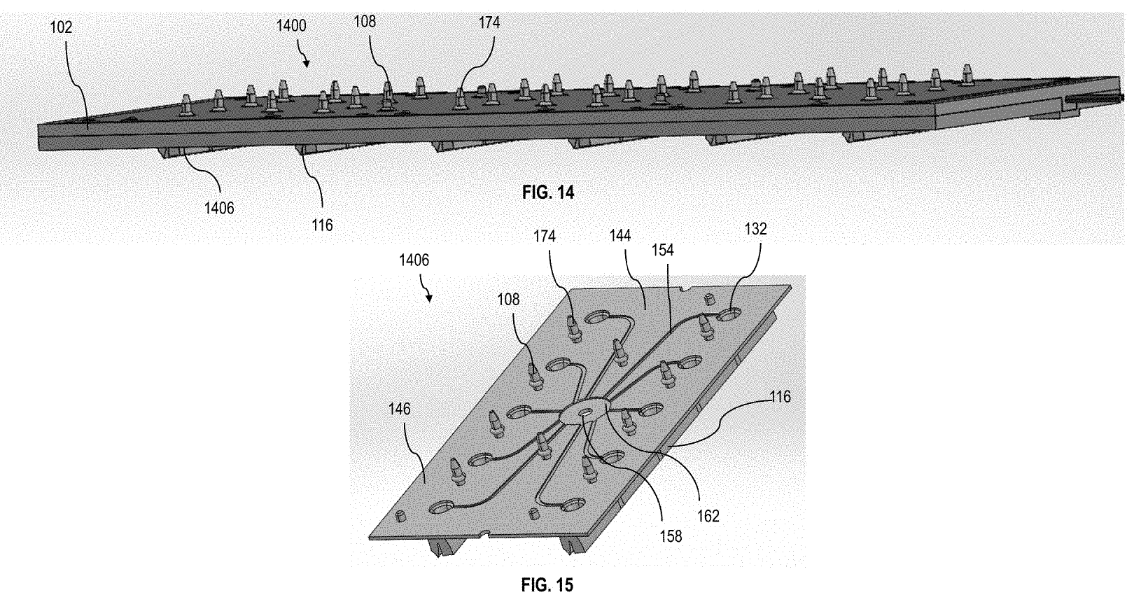

FIGS. 14 and 15 illustrate another example of a light module 1400 with a lens assembly 1406 that is substantially similar to the lens assembly 106 except that the lens assembly 1406 further includes one or more mechanical retaining features 174 as the attachment mechanisms 108 include. The lens assembly 1406 also includes channels 154 that are different from that of the lens assembly 106 but are discussed in greater detail below. In certain embodiments, the mechanical retaining features 174 may be attached to or be integrally formed with the lens assembly 106, and the mechanical retaining features 174 may have various profiles suitable for engaging complimentary features on the PCB 102 (e.g., apertures and/or other features as desired). As non-limiting examples, the mechanical retaining features 174 may be T-shaped, arrow-shaped as illustrated in FIGS. 14 and 15, and/or have other profiles as desired.

As mentioned, in certain embodiments, a light module may only include one type of attachment mechanism 108, although in other embodiments a light module may utilize a plurality of attachment mechanisms 108. As non-limiting examples, light module 100 utilizes both adhesive tape 164 and the compression component 166, light module 1300 only utilizes a compression component 166, and light module 1400 only utilizes the mechanical retaining features 174. Various other types and/or combinations of attachment mechanisms 108 may be utilized as desired, including but not limited to screws, bolts, clips, clasps, snap-fit features, combinations thereof, and/or other features or mechanisms as desired.

### Silicone Optics

Optics 116 having any geometry may be provided on the lens assembly 106 depending on the desired light distribution from the light module 100, and embodiments of the present disclosure should not be limited to the particular optic geometry described and illustrated herein.

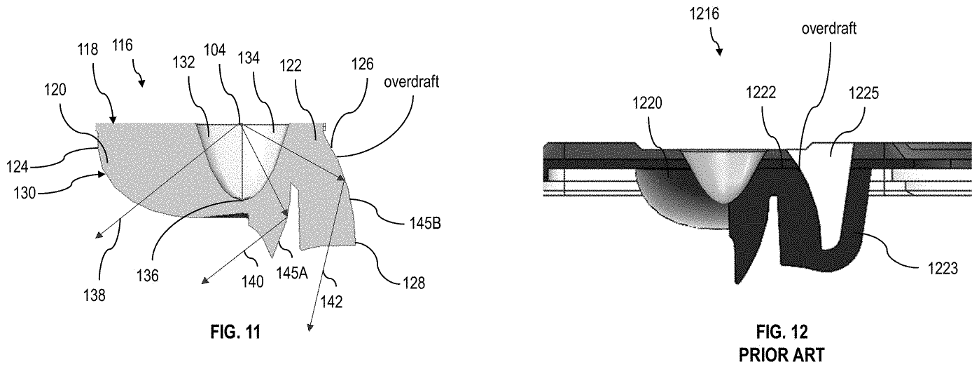

FIG. 11 illustrates an embodiment of an optic 116 that may be used in embodiments of the light modules 100 contemplated herein. Optic 116 has a base surface 118 in which an optical cavity 132 is defined by inner surface 134. In use, the optic 116 is positioned over a light source 104 such that the light source 104 emits light into the optical cavity 132. The optic 116, in turn, may refract, reflect, or otherwise alter the directionality of some of the emitted light such that light is emitted from the optic 116 in a desired pattern or distribution. In the illustrated embodiment, the optic includes a first portion 120 defining a first side 124 of the optic 116 and a second portion 122 defining a second side 126 of the optic 116. The first portion 120 and the second portion 122 may be integrally formed or formed separately and subsequently attached to each other. The first portion 120 is generally designed to receive light rays from the light source 104 and refract or otherwise emit the light rays in a direction toward the first side 124 of the optic 116 (see, e.g. light ray 138). The second portion 122 may be designed to reflect and refract light that is initially emitted from the light source 104 toward the second side 126 of the optic 116 back toward the first side 124 of the optic 116. In the illustrated embodiment, the second portion 122 may include total internal reflection surfaces 145A-B that reflect light rays and direct them out of the second portion 122 of the optic 116 and toward the first side 124 of the optic (see, e.g., light rays 140, 142). Again, however, optics 116 for use in the light modules disclosed herein may have any geometry and are not limited to the specific geometry shown in FIG. 11. Optical geometries taught in U.S. patent application Ser. No. 17/686,785, filed Mar. 4, 2022, and entitled OPTIC WITH TOTAL INTERNAL REFLECTION REFRACTOR FOR BACK LIGHT CONTROL, the entirety of which is incorporated herein by reference, may be suitable in some applications.

FIG. 12 illustrates an example of a prior art optic 1216. Similar to optic 116, optic 1216 has a first portion 1220 and a second portion 1222. However, optic 1216 also includes a tail portion 1223 and an air pocket 1225. Inclusion of a tail portion 1223 and air pocket 1225 has historically been necessary to include on optics that have an over-draft or negative taper (as is present in optic 1216) and that are formed of traditional optical materials (e.g., glass, plastic, etc.), which are rigid. The over-draft makes removal of the optic from its optic mold difficult. Moreover, because traditional optical materials are rigid, optics made from them are not pliable and thus cannot be removed from the optic mold without breaking or otherwise damaging the optic. Thus, a tail portion 1223 is typically formed with the optic. The exterior wall of the tail portion 1223 is formed with a taper or draft angle θ that permits removal of the optic from the optic mold. However, inclusion of a tail portion 1223 detrimentally affects the ability of the optic 1216 to control light (and thus the efficiency of the light module) as light can escape down the tail portion where it is effectively lost for all useful purposes. Moreover, while the portions 1220 and 1222 of the optic 1216 have a negative draft, the inclusion of the tail portion 1223 causes the overall optic 1216 to have a positive draft.

In some embodiments, the lens assembly 106 and/or subcomponents thereof (e.g., the optics 116 and/or a lens substrate 146) contemplated herein can be formed of an optical grade silicone, which can result in improved manufacturability and performance of the lens assembly. In certain embodiments, at least the optics 116 contemplated herein may be formed of an optical grade silicone, which can result in improved manufacturability and performance of at least the optics 116. In some embodiments, the optical grade silicone materials may have a refractive index of about 1.39 to about 1.43, inclusive. Additionally or alternatively, the optical grade silicone materials may have a durometer in the range of 50-90 shore A. Non-limiting examples of optical grade silicone materials that may be suitable for the optics 116 and/or the lens substrate 146 may include the silicone sold under the trade name SILASTIC™ MS-1002 Moldable Silicone by The Dow Chemical Company, the silicone sold under the trade name SILASTIC™ MS-4002 Moldable Silicone by The Dow Chemical Company, or the silicone sold under the trade name SILOPREN™ LSR 7180 by Momentive Performance Materials Inc.

In contrast with optic 1216, and with reference to FIG. 11, optic 116 is formed from optical grade silicone and does not include a tail portion 1223 or air pocket 1225. While optic 116 also includes an over-draft in its design, the silicone material from which it is made has a degree of pliability that permits optic 116 to be pulled/peeled from an optic mold without damage to the optic 116. Thus, formation of the optic 116 from a silicone material obviates the need to include extraneous features on the optic (i.e., tail portion 1223), which allows for the overall optic 116 to have a negative draft (e.g., progressively increasing in length from the base surface 118 to a lower end 128) and eliminates the resulting inefficiencies that result from inclusion of such features.

The aforementioned optics 116 are provided for illustrative purposes and should not be considered limiting. Rather, lens assembly 106 may have optics 116 having various shapes, profiles, and geometries as desired.

### Thermal Control

As best illustrated in FIGS. 8 and 9, in certain embodiment, the lens assembly 106 includes one or more thermal control features that may reduce the impact of heat generated by the light sources 104 on the other components of the light module 100. Such thermal control features may be particularly useful with optics 116 and/or lens substrates 146 formed from silicone to minimize deformation of the optics 116 and/or lens substrates 146 by controlling and/or eliminating heat that would otherwise cause the silicone to deform (e.g., by expanding or bulging outwards). However, such thermal control features are not limited to silicone components.

In some embodiments, the one or more thermal control features of the lens assembly 106 include one or more channels 154 and/or a venting feature 156. As illustrated in FIGS. 8 and 9, the one or more channels 154 may be defined in the second side 150 of the lens substrate 146. In certain embodiments, two or more channels 154 may intersect as illustrated in FIGS. 8 and 9; however, in other embodiments, the channels 154 need not intersect, and the channels 154 may be provided in any layout as desired. As an example, FIG. 15 illustrates the lens assembly 1406 that is substantially similar to the lens assembly 106 except that the channels 154 are formed in a web pattern and do not intersect each other. In certain embodiments, channels 154 are in communication with, and extend from, the optical cavities 132 in which the light sources 104 reside so as to carry away heat generated by the light sources 104 within the optical cavities 132. 132. In some embodiments and as best illustrated in FIG. 7, the channels 154 may extend in a plane that is offset above a plane of the light source 104 to provide improved venting of the hot air from the optics 116. In such embodiments, the channels 154 offset above the light source 104 may allow for air heated within the optical cavity 132 to naturally escape from the optical cavity 132 (e.g., because the channels 154 are the highest area that the air can move to).

The venting feature 156 may allow for venting of air through the lens substrate 146 from the second side 150 to the first side 148. Optionally, the one or more channels 154 may extend from the optical cavities 132 to the venting feature 156 such that the heated air may be released from the light module. Referring to FIGS. 8 and 9, in certain embodiments, the venting feature 156 may include a venting aperture 158 that extends through the lens substrate 146 and a venting member 160 covering the venting aperture 158. The venting member 160 may be formed from various materials. In some embodiments, the venting member 160 is a semi-permeable membrane that may be permeable to air but impermeable to moisture, which may minimize moisture ingress into the lens assembly 106. In some embodiments, a venting cavity 162 is defined in the second side 150 of the lens substrate 146, the venting aperture 158 may be defined in the venting cavity 162, and the venting member 160 may be positioned within the venting cavity 162. In this way, the venting member 160 does not contribute to the thickness of the lens assembly 106 such that the second side 150 of the lens substrate 146 remains flush with the underlying adhesive tape 164 and/or PCB 102.

A collection of exemplary embodiments is provided below, including at least some explicitly enumerated as “Embodiments” providing additional description of a variety of example embodiments in accordance with the concepts described herein. These embodiments are not meant to be mutually exclusive, exhaustive, or restrictive; and the disclosure not limited to these example embodiments but rather encompasses all possible modifications and variations within the scope of the issued claims and their equivalents.

Embodiment 1. A lens assembly for a light module, the lens assembly comprising: a lens comprising a substrate with a first side and a second side, wherein an optic extends from a first side of the lens and includes an optical cavity exposed on the second side of the lens, wherein the optical cavity is configured to receive a light source and wherein the second side of the lens defines a channel extending from the optical cavity.

Embodiment 2. The lens assembly of any of the preceding or subsequent embodiments or combination of embodiments, wherein the lens comprises an aperture configured to receive a light source, and wherein the optic extends over the aperture.

Embodiment 3. The lens assembly of any of the preceding or subsequent embodiments or combination of embodiments, wherein the lens comprises a venting feature configured to provide venting of the optical cavity.

Embodiment 4. The lens assembly of any of the preceding or subsequent embodiments or combination of embodiments, wherein the venting feature is configured to provide venting through the lens from the second side to the first side.

Embodiment 5. The lens assembly of any of the preceding or subsequent embodiments or combination of embodiments, wherein the channel extends from the optical cavity to the venting feature.

Embodiment 6. The lens assembly of any of the preceding or subsequent embodiments or combination of embodiments, wherein the venting feature comprises a venting aperture that extends through the substrate of the lens and a venting member that covers the venting aperture.

Embodiment 7. The lens assembly of any of the preceding or subsequent embodiments or combination of embodiments, wherein the optic comprises silicone.

Embodiment 8. A light module comprising: a printed circuit board with at least one light source; a lens assembly comprising a lens with at least one silicone optic; and a fastening mechanism connecting the lens to the printed circuit board and such that the at least one silicone optic is provided over the at least one light source.

Embodiment 9. The light module of any of the preceding or subsequent embodiments or combination of embodiments, wherein the fastening mechanism comprises an adhering mechanism adhering the lens to the printed circuitry board and such that the at least one silicone optic is provided over the at least one light source.

Embodiment 10. The light module of any of the preceding or subsequent embodiments or combination of embodiments, wherein adhering mechanism comprises adhesive tape.

Embodiment 11. The light module of any of the preceding or subsequent embodiments or combination of embodiments, wherein the fastening mechanism maintains a relative location between an optical cavity of the at least one silicone optic and the at least one light source.

Embodiment 12. The light module of any of the preceding or subsequent embodiments or combination of embodiments, wherein the fastening mechanism comprises one or more mechanical retaining features extending from the lens assembly.

Embodiment 13. The light module of any of the preceding or subsequent embodiments or combination of embodiments, wherein the one or more mechanical retaining features are arrow-shaped projections or T-shaped projections, and wherein the one or more mechanical retaining features are configured to engage one or more apertures defined in the printed circuitry board.

Embodiment 14. An optic for a light module, the optic comprising: a base surface; a lower end opposite from the base surface; a first side; and a second side opposite from the first side, wherein the optic comprises a negative draft in a direction from the base surface to the lower end, and wherein the optic comprises silicone.

Embodiment 15. The optic of any of the preceding or subsequent embodiments or combination of embodiments, wherein the optic further comprises: a first portion comprising an outer surface and a cavity defined in the base surface having a cavity surface, wherein the cavity is configured to receive a light source and comprises a cavity axis, wherein the first portion is configured to refract first light rays from the light source, and wherein the first portion defines a first side of the optic; and a second portion integrally formed with the first portion and defining a second side of the optic.

Embodiment 16. The optic of any of the preceding or subsequent embodiments or combination of embodiments, wherein the cavity surface comprises a non-linear curvature.

Embodiment 17. The optic of any of the preceding or subsequent embodiments or combination of embodiments, wherein the second portion comprises a total internal reflection surface configured to reflect second light rays from the light source toward the first side of the optic.

Embodiment 18. The optic of any of the preceding or subsequent embodiments or combination of embodiments, wherein the total internal reflection surface is a first total internal reflection surface, and wherein the second portion comprises a plurality of total internal reflection surfaces.

Embodiment 19. The optic of any of the preceding or subsequent embodiments or combination of embodiments, wherein the silicone of the optic has a refractive index of about 1.39 to about 1.43, inclusive.

Embodiment 20. The optic of any of the preceding or subsequent embodiments or combination of embodiments, wherein the silicone of the optic has a durometer in the range of 50-90 shore A.

Embodiment 21. A lens assembly for a light module, the lens assembly comprising: a lens comprising a substrate with a first side and a second side, wherein an optic extends from a first side of the lens and includes an optical cavity exposed on the second side of the lens, wherein the optical cavity is configured to receive a light source and wherein the second side of the lens defines a channel extending from the optical cavity.

Embodiment 22. A light module comprising: a printed circuit board with at least one light source; a lens assembly comprising a lens with at least one silicone optic; and an adhering mechanism adhering the lens to the PCB and such that the at least one silicone optic is provided over the at least one light source.

Embodiment 23. A lens assembly for a light module, the lens assembly comprising: a lens comprising a substrate with a first side and a second side, wherein the lens comprises an aperture configured to receive a light source; and an optic provided on the first side of the lens and positioned over the aperture configured to receive the light source, wherein the lens comprises a venting feature configured to provide venting through the lens from the second side to the first side.

Embodiment 24. A light module comprising: a printed circuit board with at least one light source; a silicone lens assembly comprising a lens with at least one optic; and an adhering mechanism adhering the silicone lens assembly to the PCB and such that the at least one optic is provided over the at least one light source.

Embodiment 25. An optic for a light module, the optic comprising: a base surface; a first portion comprising an outer surface and a cavity defined in the base surface having a cavity surface, wherein the cavity is configured to receive a light source and comprises a cavity axis, wherein the cavity surface comprises a non-linear curvature, wherein the first portion is configured to refract first light rays from the light source, and wherein the first portion defines a first side of the optic; and a second portion integrally formed with the first portion and defining a second side of the optic, wherein the second portion comprises a total internal reflection surface configured to reflect second light rays from the light source toward the first side of the optic, wherein the optic comprises silicone.

Embodiment 26. An optic for a light module, the optic comprising: a base surface; a lower end opposite from the base surface; a first side; and a second side opposite from the first side, wherein the optic comprises a negative draft in a direction from the base surface to the lower end, and wherein the optic comprises silicone.

Throughout this description for the purposes of explanation, numerous specific details are set forth in order to provide a thorough understanding of the many aspects and embodiments disclosed herein. It will be apparent, however, to one skilled in the art that the many aspects and embodiments may be practiced without some of these specific details. In other instances, known structures and devices are shown in diagram or schematic form to avoid obscuring the underlying principles of the described aspects and embodiments.

The various aspects, embodiments, implementations or features of the described embodiments can be used separately or in any combination. In particular, it should be appreciated that the various elements of concepts from the figures may be combined without departing from the spirit or scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the figure (or figures) to which the components and directions are referencing. The terms “comprising,” “having,” “including,” and “containing” are to be construed as open-ended terms (i.e., meaning “including, but not limited to,”) unless otherwise noted. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A lens assembly for a light module, the lens assembly comprising:
a lens comprising a substrate with a first side and a second side, wherein an optic extends from a first side of the lens and includes an optical cavity exposed on the second side of the lens, wherein the optical cavity is configured to receive a light source and
wherein the second side of the lens defines a channel extending from the optical cavity.

2. The lens assembly of claim 1, wherein the lens comprises an aperture configured to receive a light source, and wherein the optic extends over the aperture.

3. The lens assembly of claim 1, wherein the lens comprises a venting feature configured to provide venting of the optical cavity.

4. The lens assembly of claim 3, wherein the venting feature is configured to provide venting through the lens from the second side to the first side.

5. The lens assembly of claim 3, wherein the channel extends from the optical cavity to the venting feature.

6. The lens assembly of claim 3, wherein the venting feature comprises a venting aperture that extends through the substrate of the lens and a venting member that covers the venting aperture.

7. The lens assembly of claim 1, wherein the optic comprises silicone.

8. A light module comprising:
a printed circuit board (PCB) with at least one light source;
a lens assembly comprising a lens with at least one silicone optic; and
a fastening mechanism connecting the lens to the PCB and such that the at least one silicone optic is provided over the at least one light source.

9. The light module of claim 8, wherein the fastening mechanism comprises an adhering mechanism adhering the lens to the PCB and such that the at least one silicone optic is provided over the at least one light source.

10. The light module of claim 9, wherein adhering mechanism comprises adhesive tape.

11. The light module of claim 8, wherein the fastening mechanism maintains a relative location between an optical cavity of the at least one silicone optic and the at least one light source.

12. The light module of claim 8, wherein the fastening mechanism comprises one or more mechanical retaining features extending from the lens assembly.

13. The light module of claim 12, wherein the one or more mechanical retaining features are arrow-shaped projections or T-shaped projections, and wherein the one or more mechanical retaining features are configured to engage one or more apertures defined in the PCB.

14. An optic for a light module, the optic comprising:
a base surface;
a lower end opposite from the base surface;
a first side; and
a second side opposite from the first side,
wherein the optic comprises a negative draft in a direction from the base surface to the lower end, and
wherein the optic comprises silicone.

15. The optic of claim 14, wherein the optic further comprises:
a first portion comprising an outer surface and a cavity defined in the base surface having a cavity surface, wherein the cavity is configured to receive a light source and comprises a cavity axis, wherein the first portion is configured to refract first light rays from the light source, and wherein the first portion defines a first side of the optic; and
a second portion integrally formed with the first portion and defining a second side of the optic.

16. The optic of claim 15, wherein the cavity surface comprises a non-linear curvature.

17. The optic of claim 15, wherein the second portion comprises a total internal reflection (TIR) surface configured to reflect second light rays from the light source toward the first side of the optic.

18. The optic of claim 17, wherein the TIR surface is a first TIR surface, and wherein the second portion comprises a plurality of TIR surfaces.

19. The optic of claim 14, wherein the silicone of the optic has a refractive index of about 1.39 to about 1.43, inclusive.

20. The optic of claim 14, wherein the silicone of the optic has a durometer in a range of 50-90 shore A.
